(19) United States
(12) Patent Application Publication
(10) Pub. No.: US 2019/0217523 A1
(43) Pub. Date: Jul. 18, 2019

(54) TRANSFER AND FEED UNIT FOR PARISONS

(71) Applicant: M. TANNER AG, Illnau (CH)

(72) Inventor: MARCEL Tanner, Bassersdorf (CH)

(73) Assignee: M. TANNER AG, Illnau (CH)

(21) Appl. No.: 16/242,235

(22) Filed: Jan. 8, 2019

(30) Foreign Application Priority Data
Jan. 18, 2018 (EP) 18152394.5

(51) Int. Cl. B29C 49/42; B29C 49/06

(52) U.S. Cl. CPC B29C 49/4205; B29K 2105/253; B65G 2201/0244; B29C 49/06

(57) ABSTRACT

A transfer and feed unit for parisons, in particular for PET bottles. The transfer and feed unit can be loaded with parisons at the upstream end thereof and feeds the parisons to a conveying unit arranged at the downstream end of the transfer and feed unit. The transfer and feed unit has a first conveyor belt and a second conveyor belt, and the second conveyor belt is arranged at the downstream end of the first conveyor belt, and the first conveyor belt feeds the parisons to the second conveyor belt, and the second conveyor belt feeds the parisons to the conveying unit arranged at the downstream end thereof and a distance sensor is arranged in the downstream end region of the second conveyor belt.

The invention relates to a transfer and feed unit for parisons, in particular for PET bottles, wherein the transfer and feed unit can be loaded with parisons at the upstream end thereof and feeds the parisons to a conveying unit arranged at the downstream end of the transfer and feed unit.

DE 203 08 513 U1 discloses a device for feeding parisons or preforms composed of thermoplastic having a support ring in the region of the open end to a blowing machine for the production of hollow bodies, having a silo set up close to the ground for the unordered reception of a plurality of parisons, a roller sorter, which aligns the parisons into a position with the open end facing upward and forms them into a single row, an inclined conveyor, which moves the parisons in an unordered manner from the silo to the roller sorter, and a downward-sloping chute, which has support rails that engage under the support rings, receives a plurality of parisons in a row with the open end facing upward and feeds these by gravity to the blowing machine, wherein the roller sorter is set up close to the ground and an elevator that raises the parisons is inserted between the roller sorter and the raised upper end of the chute. In this device, the silo is filled periodically from above by means of a corresponding tipping device by tipping in parisons supplied in boxes.

The disadvantage with this solution is that the parisons can be damaged or scratched by the tipping operation or impact in the silo and that a very high noise level is produced during this process.

A device for loading a conveying system with a large quantity of parts, such as parisons or preforms for hollow bodies, is described in WO 2012/126129 A1. Here, the device comprises a tipping device having a pivotable tipper part and a device for temporary storage of the parts, wherein the device for temporary storage is a silo having a removable cover, and the tipping device has a mechanical connecting and force transmission element, which is connected to the removable cover of the silo. In this solution too, damage/scratches on the parisons may occur due to the tipping operation, and there may be an increased noise level.

In EP 17189934.7 (not yet published on the filing date of the present application), a transfer and feed unit for parisons, in particular for PET bottles, is specified, which transfer and feed unit can be loaded with parisons at the upstream end thereof and feeds the parisons to a conveying unit arranged at the downstream end of the transfer and feed unit, wherein the transfer and feed unit has a first conveyor belt and a second conveyor belt, wherein a hopper-type device is provided at the downstream end of the first conveyor belt and by this means the parisons reach the second conveyor belt, which feeds the parisons to the conveying unit arranged at the downstream end thereof.

This solution is suitable particularly for high transfer rates (i.e. around 50,000 parisons per hour). However, it is relatively complex and expensive.

It is therefore the object of the present invention, particularly for applications with relatively low transfer rates, to provide a less complex and less expensive solution which nevertheless offers virtually the same advantages.

According to the invention, this object is achieved by a transfer and feed unit for parisons, in particular for PET bottles, wherein the transfer and feed unit can be loaded with parisons at the upstream end thereof and feeds the parisons to a conveying unit arranged at the downstream end of the transfer and feed unit, wherein the transfer and feed unit has a first conveyor belt and a second conveyor belt, wherein the second conveyor belt is arranged at the downstream end of the first conveyor belt, wherein the first conveyor belt feeds the parisons to the second conveyor belt, wherein the second conveyor belt feeds the parisons to the conveying unit arranged at the downstream end thereof and wherein a distance sensor is arranged in the upstream end region (i.e. in the inlet) of the second conveyor belt.

In the present case, the conveying unit is not part of the transfer and feed unit claimed.

In a preferred embodiment of the present invention, the first conveyor belt and the second conveyor belt are arranged at a right angle to one another. In this way, a space-saving setup can be achieved.

In another preferred embodiment of the present invention, a slope, via which the parisons slide onto the second conveyor belt, is arranged at the downstream end of the first conveyor belt. The slope is intended to ensure as smooth as possible a transfer of the parisons from the first to the second conveyor belt and good distribution of the parisons on the second conveyor belt. The slope furthermore comprises a dirt separator, preferably in the form of slots, to ensure that dirt or contaminants cannot reach the second conveyor belt.

In another preferred embodiment of the present invention, the slope extends at least over the entire width of the first conveyor belt and, as a further preference, approximately as far as the center of the second conveyor belt. On the one hand, this ensures uniform distribution of the parisons along the length of the second conveyor belt and also preferably ensures optional and variable narrowing or constriction of the second conveyor belt. In this regard, the distance sensor can be offset laterally along the rear wall of the second conveyor belt, depending on the size of the parisons.

In another preferred embodiment of the present invention, a first sensor (preferably in the form of a photoelectric barrier) is arranged in the upstream end region of the first conveyor belt. If the first sensor or the first photoelectric barrier no longer detects any parisons, the tipping device returns to its initial or loading position in order to pick up a new box or a new batch of parisons.

In another preferred embodiment of the present invention, a second sensor (preferably in the form of a photoelectric barrier) is arranged between the first sensor and the downstream end region of the first conveyor belt. If the second sensor or the second photoelectric barrier does not detect any parisons, the tipping device usually provided for loading the first conveyor belt can move back into the tipping position and tip a new batch of parisons onto the belt without the risk of parisons backing up or rolling back. During this process, the first conveyor belt fundamentally moves at its normal transfer rate. In the present case, the tipping device is not part of the transfer and feed unit claimed.

In another preferred embodiment of the present invention, a third sensor (preferably in the form of a photoelectric barrier) is arranged in the downstream end region of the first conveyor belt. If the third sensor does not detect any parisons within its range, a higher speed is input into the first conveyor belt in order to supply more parisons from behind.

In another preferred embodiment of the present invention, the (adjustable) distance sensor monitors when the second conveyor belt is free from parisons across the width of the first conveyor belt (optionally also approximately at the level of the downstream end of the slope). As long as this is not the case, no further parisons are delivered to the second conveyor belt by the first conveyor belt. That is to say if the third sensor detects parisons within its range and the distance sensor (still) detects parisons in the region of the width of the first conveyor belt (optionally also in front of the downstream end of the slope) on the second conveyor belt, the first conveyor belt is stopped.

Only when the distance sensor indicates that this region is free from parisons (i.e. the parisons have been carried past the first conveyor belt or the downstream end of the slope in the transfer direction) is the first conveyor belt restarted in order to supply more parisons. This is intended to prevent the formation of heaps or to prevent incoming parisons from falling onto other parisons and scratching them while additionally producing noise. The carpet of parisons on the first conveyor belt is thus controlled by way of the speed. The drive of the first conveyor belt thus comprises a start-stop mechanism.

In another preferred embodiment of the present invention, a further sensor is arranged in the region of the downstream end of the slope. By means of this sensor, the speed of the second conveyor belt can be controlled. When the sensor is free (i.e. when it does not detect any parisons within its range), the speed of the second conveyor belt is increased, by means of a frequency converter for instance.

When the further sensor is occupied, the speed of the second conveyor belt is reduced. In this way, optimally uniform regulation of the quantity of parisons can be ensured without loss of time. The further sensor should preferably be mounted close to the point of transfer to the rucksack silo to ensure that no parisons are propelled into the rucksack silo when switching over to high-speed operation. The setting of the frequency converter can optionally be chosen in such a way that a fast, slow or constant belt speed is possible.

In another preferred embodiment of the present invention, the sensors (i.e. apart from the distance sensor) are designed as photoelectric barriers. This form of sensor has proven particularly reliable and efficient for the application taken as a basis here. Moreover, all the sensors are connected to a conventional controller.

In another preferred embodiment of the present invention, the first conveyor belt is loaded by means of a tipping device arranged at the upstream end thereof. This has proven advantageous in combination with the described speed control of the first conveyor belt.

In another preferred embodiment of the present invention, the second conveyor belt introduces the parisons into a buffer device preferably designed as a rucksack silo, which is arranged in front of the conveying unit. This buffer device ensures that the conveying unit or elevator can deliver further parisons to downstream units when there is a correspondingly large gap on the second (and possibly also the first) conveyor belt.

As a further preference, the rucksack silo or buffer device at least has a maximum sensor for the parison filling level. If the maximum filling level is reached, the second conveyor belt and optionally also the first conveyor belt are stopped. The rucksack silo or buffer device can furthermore also have a minimum sensor. If the minimum filling level is reached, a higher speed is input into the second and optionally also the first conveyor belt.

In another preferred embodiment of the present invention, the first conveyor belt is designed as a soft belt. In this way, damage to and/or scratches on the parisons as they are tipped onto the first conveyor belt is/are avoided and, in addition, noise can be reduced. The second (cross) conveyor belt can also be designed as a soft belt in a corresponding manner.

In another preferred embodiment of the present invention, the first conveyor belt has a length of between 2000 mm and 3000 mm, preferably between 2250 mm and 2750 mm. As a further preference, the first conveyor belt has a width of 1500 mm to 3500 mm, preferably from 2000 mm to 3000 mm.

In another preferred embodiment of the present invention, the second conveyor belt has a length of between 2000 mm and 5000 mm, preferably between 2500 mm and 4000 mm. As a further preference, the second conveyor belt has a width of 200 mm to 1000 mm, preferably from 200 mm to 500 mm.

Through the use of the above-described sensors or the corresponding control/regulating mechanism, it is possible, in particular, to use a relatively short first conveyor belt. Above all, there is no need to provide an additional (longitudinal) conveyor belt adjoining the first conveyor belt in order to move the quantity of parisons apart sufficiently ahead of the second (cross) conveyor belt with a view to operation which is as continuous as possible.

In the attached drawings, illustrative embodiments of the present invention will be illustrated purely for the purpose of clarity.

In the drawings:

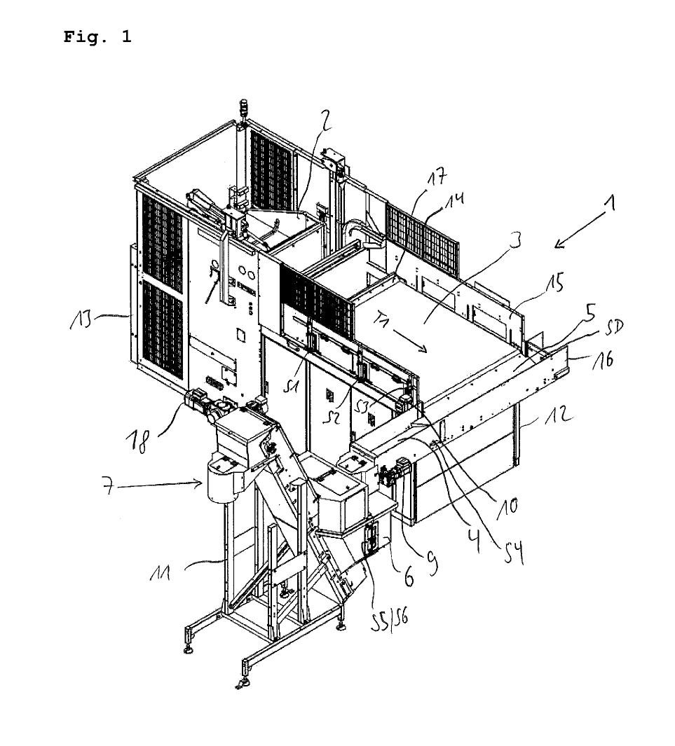

FIG. 1 shows a perspective view of an arrangement comprising a transfer and feed unit according to the invention having an upstream tipping device and a downstream elevator;

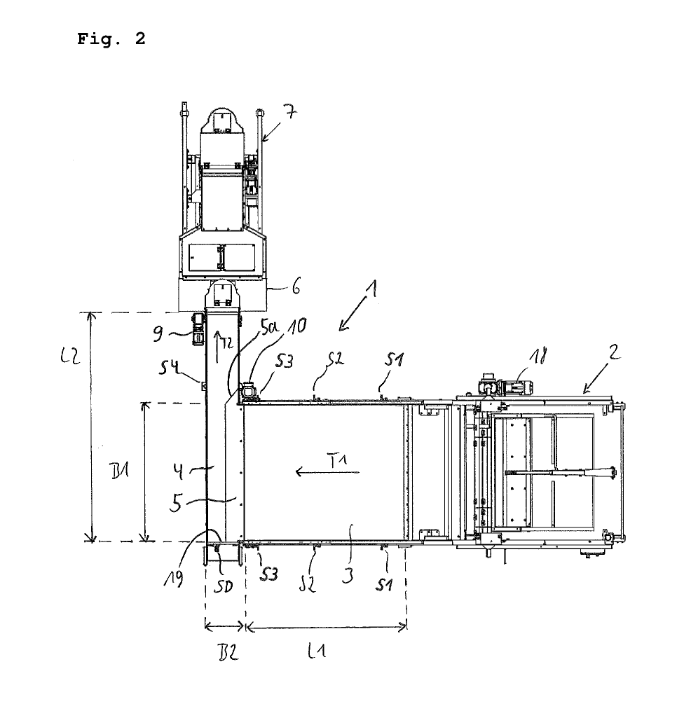

FIG. 2 shows a plan view of the arrangement having the transfer and feed unit according to the invention with the tipping device arranged upstream and the elevator arranged downstream, in accordance with FIG. 1;

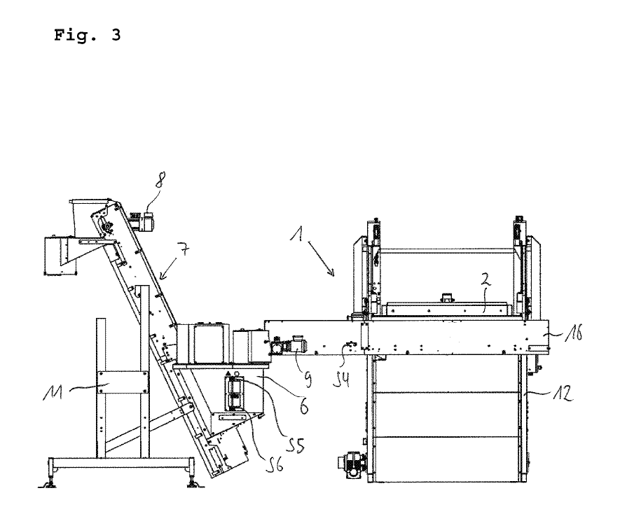

FIG. 3 shows a side view of the arrangement having the transfer and feed unit according to the invention with the tipping device arranged upstream and the elevator arranged downstream, in accordance with FIG. 1.

FIG. 1 illustrates an arrangement comprising a transfer and feed unit 1 according to the invention having an upstream tipping device 2 and a downstream elevator 7. An arrangement of this kind is often part of a conveying system by means of which parisons are transferred into a stretch blowmolding machine.

In this process, the tipping device 2 is first of all loaded with parisons (e.g. with a box full of parisons), which are then tipped onto the first conveyor belt 3 of the transfer and feed unit 1 according to the invention.

The first conveyor belt 3 brings the parisons as far as the slope 5, via which the parisons are transferred to the second conveyor belt 4. The slope 5 comprises a dirt separator, preferably in the form of slots, to ensure that dirt or contaminants cannot reach the second conveyor belt 4. The second conveyor belt 4 preferably brings the parisons into a buffer device, here in the form of a rucksack silo 6. Via the rucksack silo, the parisons then enter the conveying unit or elevator 7.

Adjoining the elevator 7 there is usually a roller sorter (not shown), in which the parisons are positioned upright. Via a downward-sloping rail, the parisons finally enter a stretch blowmolding machine (not shown). However, the stretch blowmolding machine can also be preceded by an inspection and ejector unit, in which the parisons are separated and checked for possible damage and excluded if necessary.

The region of the transfer and feed unit 1 according to the invention with the gratings 14 mounted on the side walls 15 and the backstop 17 on the upstream end of the first conveyor belt 3 are intended to interact with the tipping device 2 in such a way that, as the first conveyor belt 3 is loaded with the parisons, no parisons fall off at the sides or get stuck or roll back at the interface between the tipping device 2 and the first conveyor belt 3. The tipping device 2 is arranged in a stand 13 and is driven by a drive 18.

In the transfer and feed device 1 according to the invention, the distance by which the parisons fall from the tipping device 2 onto the first conveyor belt 3, which is generally designed as a soft belt, is preferably less than 100 mm, ensuring that the parisons do not suffer any damage/scratches due to the tipping operation and the noise level can be kept down.

After the tipping operation, the parisons are moved to the slope 5 by means of the first conveyor belt 3 in the transfer direction T1. During this process, the first conveyor belt 3 is driven by means of a drive 10 and supported by a stand 12. Covers can also be provided over the first conveyor belt 3 for reasons of hygiene.

A slope 5 is provided at the interface between the first conveyor belt 3 and the second conveyor belt 4, said slope ensuring that the parisons are transferred as smoothly as possible onto the second conveyor belt 4.

The second conveyor belt 4 brings the parisons to the rucksack silo 6, which is positioned ahead of the elevator 7. The elevator is supported by a stand 11.

The arrangement of the individual sensors on the first conveyor belt 3 (sensors S1, S2 and S3), on the second conveyor belt 4 (sensors SD and S4) and on the rucksack silo 6 (sensors S5 and optionally S6), in particular, is now described with reference to FIGS. 2 and 3.

As can be seen, sensor S1 is arranged in the initial region of the first conveyor belt 3, sensor S2 is arranged in the central region of the first conveyor belt 3 and sensor S3 is arranged in the end region of the first conveyor belt 3 (that is to say in each case above the first conveyor belt 3 in the side wall 15). Sensors S1, S2 and S3 are preferably designed as photoelectric barriers and connected to a conventional controller (not shown).

If sensor S1 detects that there are no parisons in the initial region of the first conveyor belt 3, the tipping device 2 is accordingly commanded to move into the loading or initial position in order to pick up a new box or a new batch of parisons.

If the first sensor S1 (or the first photoelectric barrier) no longer detects any parisons within its range, the tipping device 2 returns to its initial or loading position in order to be loaded with new parisons.

A second sensor S2 is arranged between the first sensor S1 and the downstream end region of the first conveyor belt 3. If the second sensor S2 (or the second photoelectric barrier) does not detect any parisons within its range, the tipping device 2 is moved back into the tipping position, and a new batch of parisons is tipped onto the first conveyor belt 3 without the risk of parisons backing up or rolling back. During this process, the first conveyor belt 3 fundamentally moves at its normal transfer rate.

A third sensor S3 is furthermore arranged in the downstream end region of the first conveyor belt 3. If the third sensor does not detect any parisons within its range, a higher speed is input into the first conveyor belt 3 in order to supply more parisons from behind.

The adjustable distance sensor SD is arranged in the (front side of the) rear wall 19 of the second conveyor belt 4. The distance sensor SD scans the parisons on the second conveyor belt 4 and in this way monitors when the second conveyor belt 4 is free from parisons over the width B1 of the first conveyor belt 3 (and, where appropriate, also approximately as far as the level of the downstream end of the slope 5, i.e. the lateral bevel 5a). As long as this is not the case, no further parisons are delivered to the second conveyor belt 4 by the first conveyor belt 3.

That is to say if the third sensor S3 detects parisons within its range and the distance sensor SD (still) detects parisons in the transfer direction T2 across the width B1 of the first conveyor belt 3 (optionally also in front of the downstream end of the slope 5) on the second conveyor belt 4, the first conveyor belt 3 is stopped.

Only when the distance sensor SD indicates that the corresponding region is free from parisons is the first conveyor belt 3 restarted in order to supply more parisons.

This is intended to prevent the formation of heaps or to prevent incoming parisons from falling onto other parisons and scratching them while additionally producing noise. The carpet of parisons on the first conveyor belt 3 is thus controlled by way of the speed. The drive 10 of the first conveyor belt thus comprises a start-stop mechanism.

A further sensor S4 is preferably arranged in the region of the downstream end of the slope 5. By means of sensor S4, the speed of the second conveyor belt 4 can be controlled. When sensor S4 is free (i.e. when it does not detect any parisons within its range), the speed of the second conveyor belt 4 is increased.

When sensor S4 is occupied (i.e. when it detects parisons within its range), however, the speed of the second conveyor belt 4 is reduced. In this way, optimally uniform regulation of the quantity of parisons can be ensured without loss of time.

(Further) sensor S4 should preferably be mounted close to the point of transfer to the rucksack silo 6 to ensure that no parisons are propelled into the rucksack silo 6 when switching over to high-speed operation. The setting of the frequency converter can optionally be chosen in such a way that a fast, slow or constant belt speed is possible.

As can furthermore be seen, the slope 5 extends at least over the entire width B1 of the first conveyor belt 3 and, as a further preference, approximately as far as the center or up to half the width B2 of the second conveyor belt 4. On the one hand, this ensures uniform distribution of the parisons along the length of the second conveyor belt 4 and also preferably ensures optional and variable narrowing or constriction of the second conveyor belt 4. In this regard, the distance sensor SD can be offset laterally along the rear wall 19, depending on the size of the parisons.

The rear wall 19 is preferably designed to enable it to be folded over in order to enable it to be used to empty the second conveyor belt 4 if said conveyor belt is operated in reverse.

In general, the slope 5 has a length which is somewhat greater than the width B1 of the first conveyor belt 3 since the slope 5 additionally has, at its downstream end, a lateral bevel 5a, from which the parisons T2 slide off obliquely forward in order to ensure a smoother movement of the carpet of parisons on the second conveyor belt 4.

The length L1 of the first conveyor belt 3 is between 2000 mm and 3000 mm, preferably between 2250 mm and 2750 mm. The width B1 of the first conveyor belt 3 is between 1500 mm and 3500 mm, preferably between 2000 mm and 3000 mm.

The length L2 of the second conveyor belt 4 is between 2000 mm and 5000 mm, preferably between 2500 mm and 4000 mm. The width B2 of the second conveyor belt 4 is between 200 mm and 1000 mm, preferably between 200 mm and 500 mm.

In FIG. 3 it is once again possible to see, in side view, the arrangement of sensor S4 in the side wall 16 of the second conveyor belt 4 and the arrangement of the maximum sensor S5 and of the minimum sensor S6 in the side wall of the rucksack silo 6.

In the present case, the rucksack silo 6 acts as a buffer device and ensures that the elevator 7 can continue to supply parisons to downstream units when there is a correspondingly large gap on the first and the second conveyor belt.

In this context, the rucksack silo 6 has at least one maximum sensor S5 for the parison filling level. If the maximum filling level is reached, the second conveyor belt and optionally also the first conveyor belt 3 are stopped. If the maximum sensor S5 is free, conveying continues. The rucksack silo 6 can optionally also have a minimum sensor S6. When the minimum filling level is reached, a higher speed is input into the second and optionally also the first conveyor belt 3, 4 to enable the elevator 7 to be supplied as continuously as possible with parisons.

The arrangement of the drive 9 for the second conveyor belt 4 and of the drive 8 for the elevator 7 can furthermore be seen from FIG. 3.

### LIST OF REFERENCE SIGNS

1 transfer and feed unit
2 tipping device
3 first conveyor belt
4 second conveyor belt
5 slope
5a lateral bevel
6 rucksack silo (or buffer device)
7 elevator
8 drive for elevator
9 drive for second conveyor belt
10 drive for first conveyor belt
11 stand for elevator
12 stand for first conveyor belt
13 stand for tipping device
14 side grating
15 side walls (first conveyor belt)
16 side walls (second conveyor belt)
17 backstop
18 drive for tipping device
19 rear wall of second conveyor belt (folding)
L1 length of first conveyor belt
B1 width of first conveyor belt
L2 length of second conveyor belt
B2 width of second conveyor belt
S1 sensor for first conveyor belt (initial region)
S2 sensor for first conveyor belt (central region)
S3 sensor for first conveyor belt (end region)
S4 (further) sensor for second conveyor belt
S5 maximum sensor for rucksack silo
S6 minimum sensor for rucksack silo (optional)
SD distance sensor
T1 transfer direction of first conveyor belt
T2 transfer direction of second conveyor belt

1. A transfer and feed unit for parisons, in particular for PET bottles, wherein the transfer and feed unit (1) can be loaded with parisons at the upstream end thereof and feeds the parisons to a conveying unit (7) arranged at the downstream end of the transfer and feed unit (1), wherein the transfer and feed unit (1) has a first conveyor belt (3) and a second conveyor belt (4), wherein the second conveyor belt (4) is arranged at the downstream end of the first conveyor belt (3), wherein the first conveyor belt (3) feeds the parisons to the second conveyor belt (4), wherein the second conveyor belt (4) feeds the parisons to the conveying unit (7) arranged at the downstream end thereof and wherein a distance sensor (SD) is arranged in the upstream end region of the second conveyor belt (4).

2. The transfer and feed unit as claimed in claim 1, wherein the first conveyor belt (3) and the second conveyor belt (4) are arranged at a right angle to one another.

3. The transfer and feed unit as claimed in claim 1, wherein a slope (5), via which the parisons slide onto the second conveyor belt (4), is arranged at the downstream end of the first conveyor belt (3).

4. The transfer and feed unit as claimed in claim 1, wherein the slope (5) extends at least over the entire width (B) of the first conveyor belt (3) and preferably approximately as far as the center of the second conveyor belt (4).

5. The transfer and feed unit as claimed in claim 1, wherein a first sensor (S1) is arranged in the upstream end region of the first conveyor belt (3).

6. The transfer and feed unit as claimed in claim 1, wherein a second sensor (S2) is arranged between the first sensor (S1) and the downstream end region of the first conveyor belt (3).

7. The transfer and feed unit as claimed in claim 1, wherein a third sensor (S3) is arranged in the downstream end region of the first conveyor belt (3).

8. The transfer and feed unit as claimed in claim 1, wherein the distance sensor (SD) monitors when the second conveyor belt (4) is free from parisons across the width (B1) of the first conveyor belt (3).

9. The transfer and feed unit as claimed in claim 1, wherein a further sensor (S4) is arranged in the region of the downstream end of the slope (5).

10. The transfer and feed unit as claimed in claim 1, wherein the sensors (S1), (S2), (S3), (S4), (S5) and, where applicable, (S6) are designed as photoelectric barriers.

11. The transfer and feed unit as claimed in claim 1, wherein the first conveyor belt (3) is loaded by means of a tipping device (2) arranged at the upstream end thereof.

12. The transfer and feed unit as claimed in claim 1, wherein the second conveyor belt (4) introduces the parisons into a buffer device (6) preferably designed as a rucksack silo, which is arranged in front of the conveying unit (7).

13. The transfer and feed unit as claimed in claim 1, wherein the first conveyor belt (3) is designed as a soft belt.

14. The transfer and feed unit as claimed in claim 1, wherein the second conveyor belt (4) is designed as a soft belt.

15. The transfer and feed unit as claimed in claim 1, wherein the first conveyor belt (3) has a length (L1) of between 2000 mm and 3000 mm, preferably between 2250 mm and 2750 mm.
